(19) United States
(12) Patent Application Publication
(10) Pub. No.: US 2018/0209292 A1
(43) Pub. Date: Jul. 26, 2018

(54) ACTIVE GAP CONTROL FOR TURBINE ENGINE COMPRESSOR

(71) Applicant: Safran Aero Boosters SA, Herstal (Milmort) (BE)

(72) Inventor: Stephane Hiernaux, Oupeye (BE)

(21) Appl. No.: 15/873,442

(22) Filed: Jan. 17, 2018

(30) Foreign Application Priority Data
Jan. 26, 2017 (BE) 2017/5050

(51) Int. Cl. F01D 11/24; F01D 25/18; F02C 7/14; F01D 11/12

(52) U.S. Cl. CPC F01D 11/24; F01D 25/18; F02C 7/14; F05D 2260/30; F05D 2260/205; F05D 2240/55; F05D 2260/98; F05D 2300/603; F01D 11/122

(57) ABSTRACT

A system for active control of radial gap around an annular row of rotor blades of a turbine engine, notably rotor blades of a low-pressure compressor of an aircraft turbojet engine. The system comprises an annular row of rotor blades; an outer casing around the annular row of rotor blades; a radial gap between the rotor blades and the outer casing; an oil circuit which is suitable for recovering the calories from a reduction gear box such as a planetary gear train which drives the fan. The oil circuit includes an expansion module which is configured to be expanded by the calories recovered from the oil. The expansion module is placed inside the outer casing so as to modulate its diameter around the rotor blades.

### CROSS-REFERENCE TO RELATED APPLICATIONS

This application claims the benefit, under 35 U.S.C. § 119, of BE 2017/5050 filed on Jan. 26, 2017, the disclosure of which is incorporated herein by reference in its entirety.

### FIELD

The invention relates to the field of dynamic sealing around a turbine engine rotor. More precisely, the invention concerns a system for actively controlling radial gap around an annular row of rotor blades. The invention also relates to an axial turbine engine, notably an aircraft turbojet engine or an aircraft turboprop.

### BACKGROUND

In operation, the effect of centrifugal force increases the outside diameter of the bladed turbojet engine wheels. This variation in geometry has an influence on the radial gap that the wheels define in combination with the outer casing which surrounds them. So as to control the resultant gap in an operating phase, the outer casing is deliberately expanded.

Document US 2010/0178161 A1 discloses a turbine engine which includes a compressor with an outer casing around rotor blades, and bearings which are lubricated by oil when the bearings are contacted. Since the oil heats up on contact with the bearings, the oil can be utilized to control the expansion of the casing around the blades. The radial gap between the casing and the blades can therefore be adapted in a precise manner in spite of the centrifugal force which increases the outside diameter of the annular row of blades. The pressure at the outlet of the compressor is raised. Nevertheless, the variation in the geometry of the casing remains imprecise so that the stator vanes are displaced in an uncontrollable manner.

### SUMMARY

The object of the invention is to resolve at least one of the problems posed by the prior art. More precisely, the object of the invention is to improve the outlet pressure of a compressor which is equipped with an active expansion system. Another object of the invention is also to propose a solution that is simple, resistant, light, economical, reliable, easy to produce, convenient to maintain, easy to inspect, improves the performance and reduces the flow of oil that is necessary.

In various embodiments the present disclosure provides a system for active control of radial gap in a turbine engine, the system comprising: an annular row of rotor blades; an outer casing around the row of rotor blades; a radial gap between the rotor blades and the outer casing; and an oil circuit which is suitable for recovering the calories from turbine engine equipment. In various instances the oil circuit includes an expansion module that is configured in order to deform the outer casing by means of the calories recovered from the oil, the expansion module being arranged inside the casing so as to adapt the radial gap.

According to various advantageous embodiments of the invention, the system can include one or several of the following features and characteristics, taken on their own or in accordance with all possible technical combinations:
The outer casing includes an annular wall with an inside surface, the expansion module includes an expansion ring which is arranged against the inside surface.
The expansion module is arranged axially at the level of the annular row of rotor blades.
The expansion module includes a metal material.
The casing includes a composite material with organic matrix, and especially glass fibres and/or carbon fibres.
The expansion module includes at least one duct which is provided in the radial thickness of the module.
The expansion module includes multiple ducts, for example at least four or at least eight ducts which are provided in the radial thickness of the expansion module and are distributed axially along the module.
Each duct extends along the circumference of the annular row of rotor blades.
The system additionally includes a layer of abradable material which is suitable to cooperate through abrasion with the row of rotor blades, the expansion module being arranged radially between the casing and the abradable layer.
The outer casing includes at least one annular fixing flange at a spacing axially from the expansion module, and possibly at a spacing axially from the row of rotor blades.
The expansion module includes a coefficient of expansion which is greater than the expansion module of the casing.
The reduction gear box includes a mechanical efficiency of between 0.99 and 0.95 inclusive.
The reduction gear box includes gears.
The compressor includes a plurality of annular rows of rotor blades, each module being arranged to the right of an annular row of rotor blades.
The expansion module extends over an axial fraction of the associated outer shroud, for example over between 25% and 75% of the axial length of the associated outer shroud.
The expansion module extends over the majority or over the entire axial length of the annular row of rotor blades.
The or each duct is inside the casing, and/or the shroud, and/or the associated annular wall.
The expansion module is arranged within the general thickness of the wall of the outer casing.

In various other embodiments, the present disclosure provides a turbine engine, e.g., a turbojet engine, including an annular row of rotor blades and a system for active control of radial gap around the rotor blades. In various instances the system for active control is consistent with that described above, the turbine engine, in various instances, includes a compressor, a fan, a turbine, a reduction gear box in engagement with the compressor and/or with the fan, and at least one rotating bearing.

According to various advantageous embodiments of the invention, the turbine engine can include one or several of the following features and characteristics, taken on their own or in accordance with all possible technical combinations:
The reduction gear box is suitable to convert at least: 50 kW, or 100 kW, or 220 kW of mechanical energy into thermal energy.
The compressor comprises at least two rows of stator vanes between which is placed the row of rotor blades, the expansion module being arranged between the at least two rows of stator vanes, the expansion module being arranged at a spacing axially from each annular row of stator vanes.
The compressor includes a plurality of annular rows of stator vanes and a plurality of expansion modules which are arranged in an alternating manner, the expansion modules being arranged axially between the stator vanes.
The outer casing includes at least one first outer shroud and one second outer shroud which are connected to one another at a fixing interface, at the interface, the second shroud has an inside diameter that is greater than the outside diameter of the second shroud, the expansion module being arranged axially inside the second shroud.
The reduction gear box is arranged axially at the level of the compressor, the compressor possibly includes a separation splitter upstream, the reduction gear box possibly being arranged downstream of the separation splitter.
The oil circuit lubricates the reduction gear box and/or each rotating bearing.
The reduction gear box is configured such that the rotating velocity of the compressor is greater than or equal to double or quadruple the rotating velocity of the fan.
The reduction gear box is configured such that the rotating velocity of the turbine is greater than or equal to double the rotating velocity of the compressor.
The compressor is a low-pressure compressor, and the turbine is a low-pressure turbine which rotates the low-pressure compressor.

In yet other embodiments, the present disclosure provides a system for active control of radial gap between an annular row of rotor blades and a turbine engine outer casing, the system comprising: a circuit which cools equipment of the turbine engine; the circuit includes a module which is expanded by the calories recovered by the cooling circuit, the expansion module being arranged inside the casing so as to modulate its diameter around the annular row of rotor blades.

In a general manner, the various advantageous embodiments of the invention are equally applicable to the other embodiments of the invention. Each embodiment of the invention is combinable with the other embodiments, and the embodiments of the invention are also combinable with the embodiments of the description which are additionally combinable with one another, in accordance with all the possible technical combinations.

The invention succeeds in controlling the radial gap between the casing and the rotor blades which it surrounds. The gap can be increased temporarily, or kept constant. The option allows leaks to be reduced for different operating modes of the turbine engine, for example at low speed and at high speed. Within the context of an aircraft turbojet engine, it becomes possible to optimize the efficiency at take-off, when climbing and when in cruise flight.

The position of the expansion module inside the casing allows the forces exerted on contact with the casing to be adapted. Tensile forces can be avoided throughout expansion, which simplifies the fixing interface and increases the durability of the gap control system.

By differentiating the materials of the expansion module and of the casing, the expansion modules can be adapted more such that the vane/casing gap is able to be controlled more precisely. Thus, the efficiency of the turbojet engine can be improved overall since different specific cases are optimized.

### DRAWINGS

FIG. 1 shows an axial turbine engine according to various embodiments of the invention.

FIG. 2 is a diagram of a turbine engine compressor according to various embodiments of the invention.

FIG. 3 illustrates a system for active control of radial gap for a turbine engine according to various embodiments of the invention.

### DETAILED DESCRIPTION

In the following description the terms “inner” and “outer” refer to positioning with respect to the rotational axis of an axial turbine engine. The axial direction corresponds to the direction along the rotational axis of the turbine engine. The radial direction is perpendicular to the rotational axis. Upstream and downstream are with reference to the main direction of flow of the flux in the turbine engine.

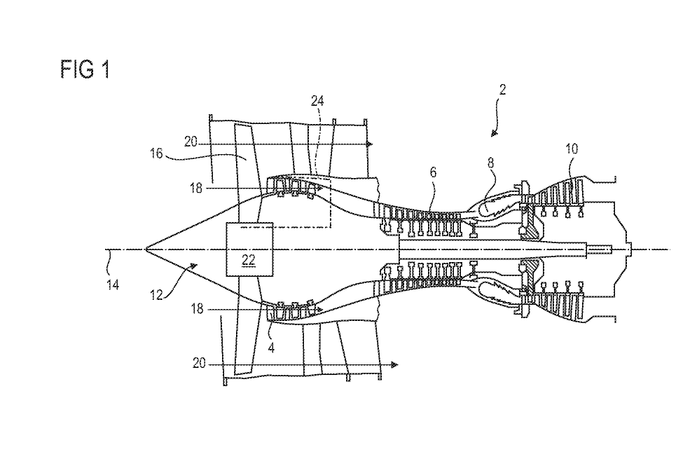

FIG. 1 shows an axial turbine engine 2 in a simplified manner. In various instances, the engine is a double-flux turbojet engine. The turbojet engine 2 includes a first level of compression, a so-called low-pressure compressor 4, a second level of compression, a so-called high-pressure compressor 6, a combustion chamber 8 and one or several levels of turbines 10. In operation, the mechanical force of the turbine 10, which is transmitted to the rotor 12 via the central shaft, sets the two compressors 4 and 6 in motion. The latter comprise multiple rows of rotor blades which are associated with rows of stator vanes. The rotation of the rotor 12 around its rotational axis 14 thus allows an airflow to be generated and the latter to be compressed progressively until entry into the combustion chamber 8.

An intake ventilator, commonly designated fan or fan 16, is coupled to the rotor 12 and generates an airflow which is divided into a primary flow 18 which traverses the different levels of the turbine engine mentioned above, and into a secondary flow 20 which traverses an annular duct (shown in part) along the machine in order then to re-join the primary flow at the turbine outlet. The secondary flow 20 can be accelerated by the fan 16 so as to generate a thrust response which allows an aircraft to fly. The fan 16 can be of the non-streamlined type, for example with two contra-rotating rotors, in various instances downstream of the turbojet engine.

A reduction gear box 22, such as an epicyclic gearing reduction gear box with one inlet and a dual outlet, can reduce the rotational velocity of the fan 16 and/or of the low-pressure compressor 4 with respect to the associated turbine. By way of example, the low-pressure turbine rotates at 20,000 rpm, the compressor at 10,000 rpm and the fan at 2,000 rpm. In operation, the reduction gear box 22 converts at least 20 kW or at least 150 kW of mechanical energy into thermal energy. It demonstrates significant self-heating.

The turbine engine 2, furthermore, is equipped with an oil circuit 24 which allows the reduction gear box 22 and possibly the bearings which articulate the mobile parts of the rotor 12 to be lubricated. The oil circuit 24 allows the reduction gear box 22 to be both lubricated and cooled, and in addition calories to be brought to the compressor 4.

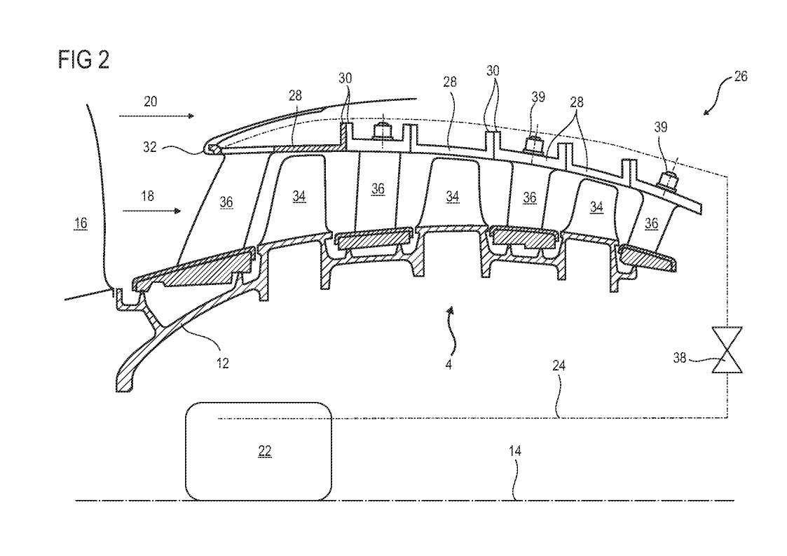

FIG. 2 is a cross-sectional view of a compressor of an axial turbine engine such as that in FIG. 1. The compressor 4 can be a low-pressure compressor 4. The compressor 4 has a casing 26 which is formed by outer shrouds 28 which are connected to one another by means of fixing flanges 30. As an alternative to this, the outer casing is formed by angular half-shells.

The separation splitter 32 of the primary flow 18 and of the secondary flow 20 can be seen. The oil circuit 24, which originates from the reduction gear box 22, brings calories to the outer casing 26, in various instances to its shrouds 28, and in various instances to the separation splitter 32. A valve 38 allows the thermal exchange of the circuit 24 to be controlled. The valve 38 can be regulated by a control system of the turbine engine.

The rotor 12 includes several annular rows of rotor blades 34, in this exemplary case three. It can be a single-piece bladed drum, or include blades to be fixed using dovetail technology. It can be formed by discs.

The reduction gear box 22 can be a transmission that rotates around the rotational axis 14. It can be arranged in the rotor 12, for example in the drum. The reduction gear box 22 can be placed inside the compressor, at least at the level axially of the compressor 4. For example, the reduction gear box 22 can be placed between the separation splitter 32 and the outlet of the compressor 4. In various instances, the compressor can include a fan-support casing which is located between the separation splitter 32 and the shrouds of the compressor 4.

The low-pressure compressor 4, also called a booster, includes multiple straighteners, in this exemplary case four, that each contain a row of stator vanes 36. The straighteners are associated with the fan 16 or with a row of rotor blades in order to straighten the airflow so as to convert the flow velocity into pressure, e.g., into static pressure. The stator vanes 36 extend substantially radially from the outer casing 26, and can be fixed and immobilized there by means of axes 39.

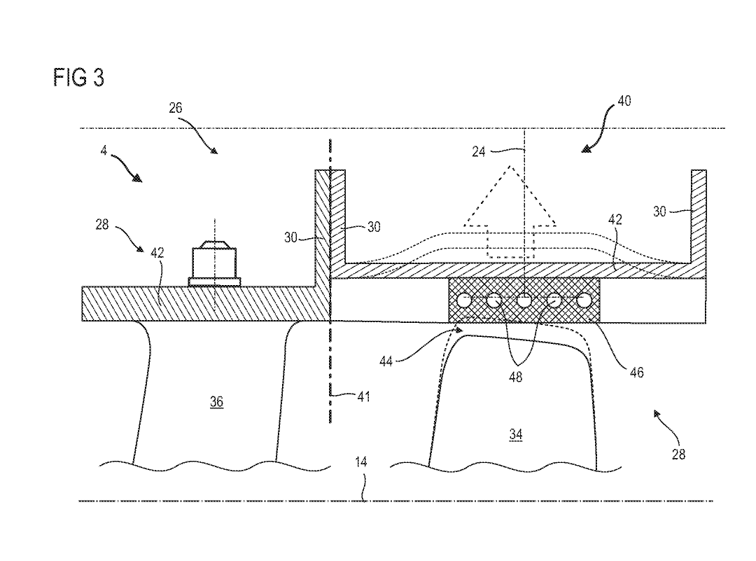

FIG. 3 is an exemplary sketch of a portion of the compressor 4 such as that shown in FIGS. 1 and 2. The portion receives a system 40 for controlling radial gap.

Two outer shrouds 28 are to the right of a row of rotor blades 34 and of a row of stator vanes 36. The shrouds 28 are connected at a fixing interface 41 where their respective annular walls 42 demonstrate a difference in inside diameter. In particular, the wall 42 around the rotor blades 34 has the largest inside diameter. Furthermore, the fixing flanges 30 are at a distance axially from the rotor and stator vanes 34 and 36.

The rotor blades 34 are shown at rest by a solid line and in operation by a broken line. The centrifugal force tends to increase the outer diameter of the row of rotor blades 34. The deformation moves them closer to their outer shroud 28, in various instances until touching it. So as to control the gap between the rotor blades 34 and the casing 26, one or several expansion modules 46 are associated with the different shrouds around the rotor blades 34. The expansion modules 46 are connected to the oil circuit 24 so as to receive the calories transported by the oil and originating from the reduction gear box.

When the expansion module 46 receives calories, it expands and increases the diameter of the casing 26. Being inside its shroud 28, it pushes the shroud from the inside. The wall 42 which is associated with the expansion module 46 is shown at rest by means of a solid line and by means of a broken line when the expansion module provides heat. In various instances, the expansion module provides the shroud 28 with calories and the shroud also expands. The deformation can be localized on the casing assembly, or specifically on an outer shroud 28, or at least one axial segment of the outer shroud 28. In various instances, the flanges 30 can generally keep a constant outside diameter, or increase the diameter in the case of the expansion module 46 acting in a thermal manner. Thereupon, the gap 44 can be modulated.

The expansion module 46 can include an annular body of material. It can form a belt that is flush against the inside surface of the annular wall 42. The expansion module 46 can be run through by a plurality of ducts 48. Each duct 48 is connected to the oil circuit 24 and allows a thermal exchange between the oil and the material of the expansion module 46, for example a metal material. The expansion module 46 can form an auxiliary heat exchanger, the circuit 24 additionally being able to include a main heat exchanger (not shown).

The material of the expansion module 46 can be different to that of the casing 26, in various instances of its installation shroud 28. The casing 26, in various instances at least one or each shroud 28, can be realized in composite material with organic matrix with glass fibres and/or carbon fibres. The coefficient of expansion of the expansion module is therefore greater than that of the casing in order to amplify the expansion.

The expansion module 46 can include five or ten ducts 48. Each duct can extend over the circumference of the row of rotor blades 34, or at least form a circular arc around the rotational axis 14. The expansion module 46 can extend over the axial majority of the associated shroud 28. The expansion module 46 can be integrated in the general thickness of the associated shroud 28. It can be placed against the annular wall 42 which presents the largest inside diameter to the interface 41, so that its inside surface comes into contact with the inside surface of the outer shroud 28 that carries the stator vanes 36.

In various embodiments, the inside surface of the expansion module 46 is covered by a layer of abradable material (not shown), also known as erodible material. The layer is intended to cooperate with the rotor blades 34 by way of abrasion. Alternatively, the expansion module 46 can face the rotor blades directly. The expansion module 46 therefore becomes a partition between the abradable material and the wall 42.

Although only one single expansion module 46 is shown, it is possible to provide several of them in the compressor in FIG. 2. For example, a module 46 can equip each outer shroud 28 around the rotor blades 34. The outer shrouds 28 that receive the stator vanes 36 can be free of such modules. Accordingly, each expansion module 46 can be at a spacing axially from each stator vane 36 and in various instances from their outer shrouds 28. The expansion modules 46 can notably remain at a spacing from the fixing flanges 30 so as to benefit from the flexibility of the walls 42. According to various embodiments of the invention, two adjoining shrouds can be merged.

What is claimed is:

1. A system for active control of radial gap in a turbine engine, said system comprising:
an annular row of rotor blades;
an outer casing around the annular row of rotor blades;
a radial gap radially between the rotor blades and the outer casing;
a turbine engine equipment: and
an oil circuit structurally and functionally adapted for recovering the calories from the turbine engine equipment, wherein the oil circuit includes an expansion module configured to radially deform by thermal expansion the outer casing by means of the calories recovered from the oil circuit, the expansion module being arranged inside the outer casing so as to reduce the radial gap.

2. The system according to claim 1, wherein the outer casing includes an annular wall with an inside surface, and the expansion module includes an expansion ring that is arranged radially against the inside surface.

3. The system according to claim 1, wherein the expansion module is arranged axially level with the annular row of rotor blades and projects axially along the annular row of rotor blades.

4. The system according to claim 1, wherein the expansion module includes a metal material that is different from the material of the outer casing, and includes a different thermal expansion coefficient from the thermal expansion coefficient of the material of the outer casing.

5. The system according to claim 1, wherein the outer casing includes a composite material with organic matrix and fibres, the fibres including at least one of glass fibres and carbon fibres.

6. The system according to claim 1, wherein the expansion module includes a duct that is provided in the radial thickness of the module, and that channels oil from the oil circuit.

7. The system according to claim 1, wherein the expansion module includes at least four ducts that are provided in the radial thickness of the expansion module and are distributed axially along the expansion module.

8. The system according to claim 6, wherein each duct extends along the circumference of the annular row of rotor blades and forms a loop around the annular row of rotor blades.

9. The system according to claim 1 further comprising a layer of abradable material that is suitable to cooperate through abrasion with the annular row of rotor blades, the expansion module being arranged radially between the outer casing and the abradable layer.

10. The system according to claim 1, wherein the outer casing includes an annular fixing flange projecting radially outside, and disposed at least one of axially remote from the expansion module and a spacing axially distant from the annular row of rotor blades.

11. A system for active control of radial gap in a turbine engine, said system comprising:
an annular row of rotor blades;
an outer casing around the annular row of rotor blades;
a radial gap between the rotor blades and the outer casing;
a turbine engine equipment; and
an oil circuit suitable for recovering the calories from the turbine engine equipment, wherein the oil circuit includes an expansion module that is configured to deform the outer casing by means of the calories recovered from the oil circuit, the expansion module being arranged inside the outer casing so as to adapt the radial gap, and wherein
the outer casing includes an annular fixing flange axially remote from the expansion module, and a spacing axially distant from the annular row of rotor blades.

12. A turbine engine, said engine comprising a compressor;
a fan;
a turbine;
a reduction gear box coupled with the compressor and with the fan;
a rotating bearing; and
a system for active control, the system comprising:
an annular row of rotor blades;
an outer casing around the annular row of rotor blades;
a radial gap between the rotor blades and the outer casing; and
an oil circuit structurally and functionally suitable for recovering the calories from the reduction gear box and from the rotating bearing, wherein the oil circuit includes an expansion module that is configured to deform the outer casing by means of the calories recovered from the oil circuit, the expansion module being arranged inside the outer casing so as to adapt the radial gap.

13. The turbine engine according to claim 12, wherein the reduction gear box is suitable to convert at least 100 kW of mechanical energy into thermal energy.

14. The turbine engine according to claim 12, wherein the compressor comprises at least two rows of stator vanes between which is placed the annular row of rotor blades, the expansion module being arranged between the at least two rows of stator vanes, the expansion module being axially spaced from each annular row of stator vanes.

15. The turbine engine according to claim 12, wherein the compressor includes a plurality of annular rows of stator vanes and a plurality of expansion modules that are arranged in an alternating manner, each expansion module being arranged axially between the stator vanes.

16. The turbine engine according to claim 12, wherein the outer casing includes at least one first outer shroud and one second outer shroud that are connected to one another at a fixing interface, at the fixing interface the second shroud has an inside diameter that is greater than an outside diameter of the second shroud, the expansion module being arranged axially inside the second shroud.

17. The turbine engine according to claim 12, wherein the reduction gear box is arranged axially level with the compressor, the compressor including a separation splitter upstream, the reduction gear box being arranged downstream of the separation splitter.

18. The turbine engine according to claim 12, wherein the reduction gear box is configured such that the rotating velocity of the compressor is greater than or equal to one of double or quadruple the rotating velocity of the fan.

19. The turbine engine according to claim 12, wherein the reduction gear box is configured such that the rotating velocity of the turbine is greater than or equal to double the rotating velocity of the compressor.

20. The turbine engine according to claim 12, wherein the compressor is a low-pressure compressor, and the turbine is a low-pressure turbine that drives the low-pressure compressor.
